(19) United States
(12) Patent Application Publication
(10) Pub. No.: US 2013/0166602 A1
(43) Pub. Date: Jun. 27, 2013

(54) CLOUD-ENABLED BUSINESS OBJECT MODELING

(71) Applicants: Frank Brunswig, Heidelberg (DE); Rakesh Kumar, Bangalore (IN); Shakul Jugran, Uttarakhand (IN); Anantharaman L, Bangalore (IN); Jeyaraj A, T.N.C Alangulam (via) (IN); Vinay Shettar, Bangalore (IN)

(72) Inventors: Frank Brunswig, Heidelberg (DE); Rakesh Kumar, Bangalore (IN); Shakul Jugran, Uttarakhand (IN); Anantharaman L, Bangalore (IN); Jeyaraj A, T.N.C Alangulam (via) (IN); Vinay Shettar, Bangalore (IN)

(73) Assignee: SAP AG, Walldorf (DE)

(21) Appl. No.: 13/335,312

(22) Filed: Dec. 22, 2011

(51) Int. Cl. G06F 17/30; G06F 15/16

(52) U.S. Cl. 707/802; 709/203; 707/E17.005

(57) ABSTRACT

A method to model and implement a business object in a consolidated user interface is disclosed. The user interface is presented to a client to form and implement a business object at a server. A structure of the business object is modeled in a metadata repository at the server based on the user interface at the client. An implementation of the structure of the business object is generated at the server and stored at the database. An enhanced controller object (ECO) calls a corresponding metadata repository application programming interface (API) and the program generation application programming interface (API)

### TECHNICAL FIELD

The present application relates generally to the field of modeling and implementing business objects of software applications, and, in one specific example, to cloud-enabled business object modeling and implementing.

### BACKGROUND

Employees of a company or enterprise may be more familiar with some software applications than others. For example, the employees may be very familiar with personal productivity applications (e.g., Microsoft Outlook), but they may not be as familiar with back-end business software applications (e.g., business intelligence; enterprise information management; enterprise performance management; governance, risk, and compliance; and analytic software applications). In particular, employees seeking to model, design, and implement business objects are required to access a variety of scattered tools that are only available via on-premise installation.

### BRIEF DESCRIPTION OF THE DRAWINGS

Some embodiments are illustrated by way of example and not limitation in the figures of the accompanying drawings in which:

FIG. 1 is a block diagram depicting an example environment within which example embodiments may be deployed;

FIG. 2 is a block diagram depicting an example of an application;

FIG. 3 is a block diagram depicting an example of a metadata repository module (MDRS);

FIG. 4 is a block diagram depicting an example of Business Object Wizard enhanced controller object;

FIG. 5 is a screenshot depicting an example user interface of a Business Object Wizard;

FIG. 6 is a screenshot depicting an example overview of a root node of a newly modeled Business Object;

FIG. 7 is a flowchart depicting an example method for creating or modeling a business object and implementing the business logic program at a server from a user interface at a client;

FIG. 8 is a flowchart depicting an example method of using a Business Object Wizard Enhanced Controller Object to create or model a business object and implement the business logic program; and

FIG. 9 is a block diagram of an example computer system on which methodologies described herein may be executed.

### DETAILED DESCRIPTION

In the following description, for purposes of explanation, numerous specific details are set forth in order to provide an understanding of various embodiments of the inventive subject matter. It will be evident, however, to those skilled in the art, that embodiments may be practiced without these specific details. Further, to avoid Obscuring the inventive subject matter in unnecessary detail, well-known instruction instances, protocols, structures, and techniques have not been shown in detail. As used herein, the term “or” may be construed in an inclusive or exclusive sense. The term “user” may be construed to include a person or a machine. The term “interface” may be construed to include an application program interface (API) or a user interface. The term “database” may be construed to include a database or a NoSQL or non-relational data store (e.g., Google's BigTable or Amazon's Dynamo). The term “business object” may mean an object that represents an entity of a business inside a software application. For example, a business object may represent a person (e.g., an employee of a company) or a concept (e.g., a process within a company) inside an enterprise information management software application.

A method to model and implement a business object in a consolidated user interface is disclosed. The user interface is presented to a client to form and implement a business object at a server. A structure of the business object is modeled in a metadata repository at the server based on the user interface at the client. An implementation of the structure of the business object is generated and stored in A database. An enhanced controller object (ECO) calls a corresponding metadata repository API and implementation program generation API.

In one embodiment, the user interace comprises business logics provided by an ECO. The ECO is configured to call a corresponding MDRS API to create and modify meta-objects for each business object. The ECO is configured to call a corresponding program generation API to create and modify business logic implementation programs. The ECO is configured to determine services to model the business object.

In another embodiment, the newly modeled business object is stored in the metadata repository at the server. The metadata repository also stores pre-existing business objects models. The newly modeled business object's implementation business logic is stored as a program in the database. The database also stores pre-existing programs. The business object from the ECO is modeled in the metadata repository and the implementation program is generated and stored in the database. The metadata repository comprises a repository metamodel, an API layer, a repository runtime, and a persistency layer.

In another embodiment, the repository metamodel comprises a business object metamodel. The API layer comprises a service layer, wherein the repository runtime comprises an implementation layer for checking consistency and activation of models, and a business object processing framework persistency layer.

In one embodiment, a structure of a metamodel of the enhanced controller object comprises a business object root, a node, a node element, an association, an action, and a query. The business object root comprises information including a name, a service provider class, and an implementing framework. The node corresponds to all nodes that the business object being modeled will have.

Traditionally, the modeling and the design of a BO is done using the MDRS workbench, while implementation is done using the various available implementation frameworks. Among all the implementation frameworks, the Business Object Processing Framework (BOPF) is the most common and popular one.

The business object (BO) developer currently models the data types for the nodes, and then models the structure of the business object in the MDRS. The developer then generates the internal representation and database persistency with the frameworks like BOPF, Object Engine, CRM Document Framework, and Procurement Document Framework.

All of these types of tools are form-based, which means that the developer has to know exactly which properties and attributes are mandatory in order to create a new business object model and which properties and attributes are optional. Also typical for a form-based editor is the fact that there is no explicit developer's guiding support like there is in well-known wizard based user tools (for example, like in Microsoft Visual Developer's Studio).

Currently, business object (BO) editors are available in the Visual ByDesign Studio, which is available for partner development, in the MDRS ABAP transaction, which is available for SAP in-house development, and in the upcoming ABAP in Eclipse development tool. All of these tools are not cloud-enabled and need an on-premise installation.

The goal of the BO wizard is to eliminate these existing gaps in the current tools and integrate these scattered tools into one comprehensive modeling and implementation tool, thereby increasing developer efficiency, especially when creating new business objects. The BO Wizard project shall enable the developer to use an SAP Business ByDesign integrated Oberon based User Interface to create, model, implement and activate a business object (BO) based on the enterprise service framework (ESF2) and get the services running immediately. With this approach, the BO Wizard is available for all kinds of developers anywhere in the world.

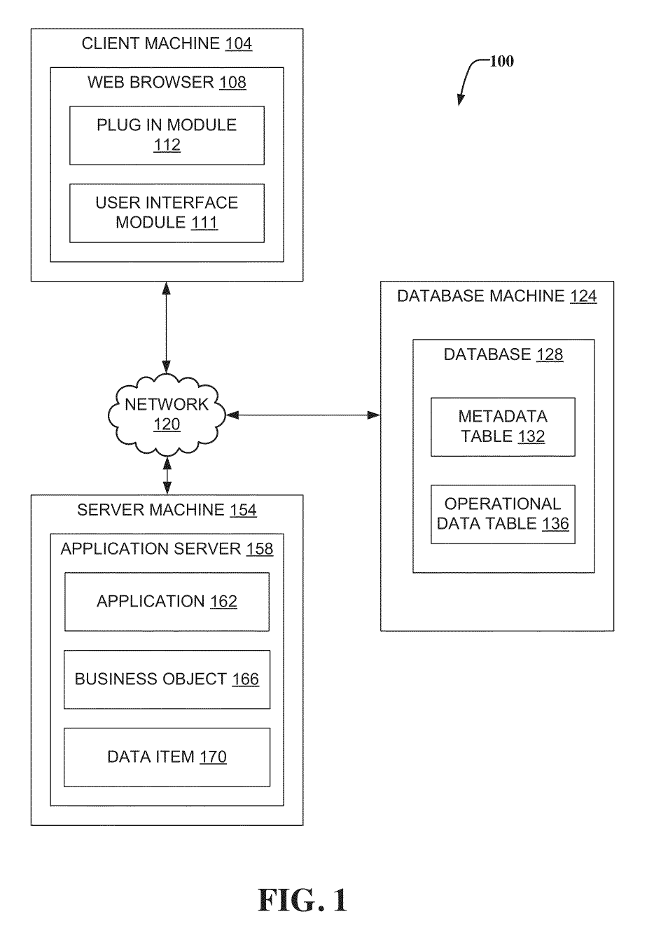

FIG. 1 is a block diagram depicting an example environment 100 within which example embodiments may be deployed. The environment 100 includes one or more client machines (e.g., client machine 104). For example, the client machine 104 may be a personal computer (PC) of an employee of a company. The client machine 104 executes a web browser 108 or a software application (e.g., application). For example, the web browser 108 may be any browser commonly used to access a network of computers such as the World Wide Web. The web browser loads a user interface 111 to create and model business objects 166.

In another embodiment, the web browser 108 includes one or more plug-ins or extensions. Although referred to herein as a “plug-in,” the plug-in 112 may not be a plug-in at all, but rather a standalone software application. For example, the plug-in 112 may be a desktop widget on which a user may drop any kind of object, such as an email, a browser link, a document, and so on. The plug-in 112 provides a mechanism for a user of the web browser 108 to create and model one or more business objects (e.g., business object 166) via the user interface 111 in the web browser 108. For example, the plug-in 112 may use native user interface elements of the web browser 108 to display a business object view (or window) inside a main window of the web browser 108. In the business object view, the plug-in 112 may display (e.g., using a tree control) a visual representation of the business object 166. The visual representation of the business object 166 may include a visual representation of one or more data items (e.g., data item 170) of the business object. A data item of the business object may be a unit of data corresponding to the business object that is managed by an application that provides the business object. The visual representation of the business object 166 may include a diagram of the relationships between the business object 166 and the one or more data items 170 of the business object 166. The visual representation of the business object 166 may also include a diagram of the relationships between the one or more data items 170 of the business object 166.

In another embodiment, the web browser 108 may not require any plug-in 112 to create and model one or more business objects. The user interface 111 may be used to create and model the business objects in the web browser 108 of the client machine 104. The user interface 111 may be generated by the application 162 and presented to the web browser 108 via network 120.

The environment 100 includes one or more server machines (e.g., server machine 154). The server machine 154 executes one or more application servers (e.g., application server 158). The server machine 154 also executes the one or more additional software applications (e.g., the application 162). For example, the server machine 154 may execute the application 162 in conjunction with the application server 158. The application 162 includes a business object wizard enhanced controller object (e.g., business object wizard enhanced controller 204). A business object 166 may correspond to one or more entities created by the application 162 that represent things in a business entity. For example, the business object 166 may map a source data structure in a database (e.g., database 128) to business terms used by non-information technology (IT) analysts. The business object 166 may also correspond to a function of the database 128. For example, the business object 166 may correspond to a person (e.g., a job candidate) who has applied for a job opening in a human resources application. The business object 166 may include one or more data items (e.g., data item 170). The data items 170 of the business object 166 may correspond to any data that the one or more additional applications maintain with respect to the business object 166. For example, the data item 170 may be a resume of a person (e.g., a candidate for an open position at a company) represented by the business object 166, or the data item 170 may be a time card of a person (e.g., an employee of a company represented by the business object 166.

The environment 100 includes one or more database machines (e.g., database machine 124). The database machine 124 includes one or more databases (e.g., database 128). The database 128 includes one or more tables maintained by the business object 166, including a metadata table 132 and an operational data table 136. The metadata table 132 includes metadata pertaining to the model of the business object 166 represented via the web browser 108 through the plug-in 112. The operational data table 136 includes data that describes or annotates associations between the business object 166 and the data item 170 of the business object 166 (or between the data item 170 and an additional data item of the business object 166) of the application 162. This operational data table 136 may be associated with any other operational data table 136 pertaining to the same business object 166 or to additional business objects pre-existing in the metamodel. The metamodel may contain the definitions of associations between the business object 166 and additional business objects, between the business object 166 and data items of the business object 166, or between data items of the business object 166 or data items of the additional business objects. The metamodel may also contain the definitions of the actions that the business object 166 supports (e.g., an “attach” action to attach an email message or attachment of an email message to the business object 166). The application 162 may store and retrieve the business logic program in the database 128 which defines how the action gets performed. The database 128 may also include source tables (not shown) into which the business logic program of the business object 166 created out of the application 162 may be stored into and retrieved from.

The client machine 104, database machine 124, and server machine 154 may be coupled to each other via a network 120. The network 120 enables communication between systems. Accordingly, the network 120 may be a mobile telephone network, a Plain Old Telephone (POTS) network, a wired network, a wireless network (e.g., a or WiMax network), or any suitable combination thereof. The communication may be based on any communication protocol. Examples of communication protocols include Transmission Control Protocol/Internet Protocol (TCP/IP), HyperText Transfer Protocol (HTTP), File Transfer Protocol (FTP), Simple Mail Transfer Protocol (SMTP), Post Office Protocol (POP), Internet Message Access Protocol (IMAP), Wireless Access Protocol (WAP), Gopher, wireless internet protocols, and instant messaging protocols. The network 120 may be implemented using the Internet, a wide area network (WAN), a local area network (LAN), or any suitable combination thereof.

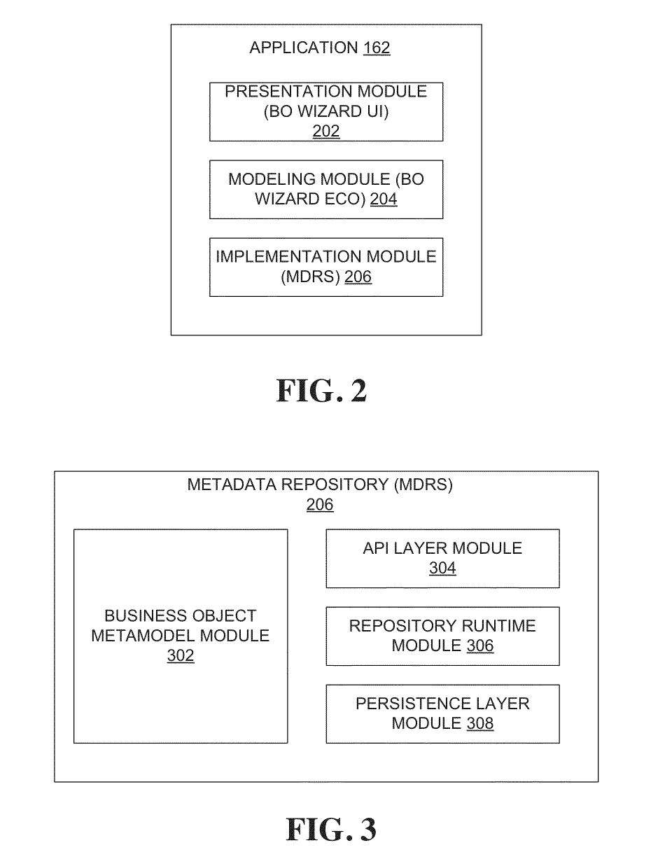

FIG. 2 is a block diagram depicting example modules of the application 162 of FIG. 1. The application 162 includes a presentation module 202 (Business Object Wizard User Interface Module) to present a user interface 111 in the web browser 108 to enable a user (business object modeler) to access e.g., create or modify and implement) a business object (e.g., the business object 166) through the application 162. For example, the presentation module 202 may use a native user interface element of the web browser 108 to display a visual representation of the business object 166 in a user interface element (e.g., a window) of application 162 within the web browser 108. The presentation module 202 may also present visual representations of the data item 170 of the business object 166. The presentation module 202 may also present a diagram of the relationships between the business object 166 and the data item 170 of the business object 166 (or between the data item 170 and an additional data item of the business object 166).

The presentation module 202 may also manage color-coding of each data item 170 based on its type. For example, a data item representing a state of the business object 166 that is maintained by the additional application 162 may be color-coded red; a data item that is merely associated with the business object 166 modeled via the application 162 (e.g., a data item that is maintained externally from the application 162 by the plug-in 112) may be color-coded blue; a non-state data item (e.g., a data item representing an action that is to be performed by the business object 166) may be color-coded yellow. The presentation module 202 may also use a user interface element of the web browser 108 to present a user interface to enable a user to search for particular business Objects of the application 162 from within the web browser 108.

The presentation module 202 may also display (e.g., in a native user interface element of web browser 108) information about the business object 166 (e.g., a business object selected by a user). For example, if the business object corresponds to a person, the presentation module 202 may display metadata information about the person, such as the node elements like person's first name, last name, email address, phone number, and position. The presentation module 202 may also display other metadata about the business object 166, such as a group of business objects to which a currently highlighted business object 166 belongs (e.g., “People”).

The application 162 includes a modeling module 204 (Business Objects Wizard Enhanced Controller Object) to model a structure of the business object in a metadata repository 206 (stored at database 128) through the server machine 154 stored at the database machine 124 based on the user interface at the client.

As an example, the modeling module 204 may create a new data item for the business object 166 based on detection of an action by the user in the user interface inside the web browser 108 (e.g., a dragging and dropping by the user of a visual representation of a new data item onto a visual representation of the business object 166). In this case, the modeling module 204 may create a new data item for the business object 166. This creation of a new data item may be based on an identification by the modeling module 204 that a data item corresponding to the new data item does not exist for the business object 166. This new data item may be associated with the business object 166 via a registration with the application 162 that provides the business object 166 (e.g., via a call to an API) or be associated with the business object 166 independently of the application 162 that provides the business object 166.

The modeling module 204 identifies relationships between the business objects of an application, between each of the business objects and their associated data items, and between each of the associated data items. The modeling module 204 may identify the relationships based on a querying of the applications containing the business objects (e.g., via an API of the applications). The modeling module 204 may also identify the relationships by analyzing the metamodel of the relationships.

The metamodel may include definitions not only of relationships between business objects (and data items of the business objects) that are maintained by an application that provides the business objects (e.g., relationships obtained from a querying of the application), but it may also include definitions of relationships pertaining to data items that are not maintained by the application that provides the business objects. For example, the modeling module 204 may identify the relationships based on a definition included in the metamodel by the plug-in 112. The metamodel may include definitions of relationships between business objects and data items of the business objects (or between data items of the business objects) that are independent of the applications that provide the business object. For example, the metamodel may include a definition of a relationship between a resume of a person and a business object that represents the person even if the application that provides the business object is unaware of such a relationship. Additionally or alternatively, definitions of relationships that are independent of the application that provides the business object may be stored separately from the metamodel (e.g., such definitions may be maintained by the web browser 108). The presentation module 204 may present the relationship between the resume and the person in the visual representation of the business object independently of any recognition by the application of such a relationship. In this way, the modeling module 204 enables a user to associate any data item with any business object of any application. The modeling module 204 may maintain definitions of relationships in the metadata table 132, in accordance with one embodiment, through the business object wizard enhanced controller.

The application 162 includes an implementation module 206 (MDRS) to generate an implementation of the structure of the business object at the server The structure of the implementation module 206 is described in further detail with respect to FIG. 3.

In one embodiment, the presentation module 202, which the BO modelers will use for modeling the BO, is built with the regular ByDesign Oberon UI technology. All UI specific logic is provided by a modeling module 204. In addition, the modeling module 204 also contains all the logic to call the relevant MDRS APIs. In one embodiment, the modeling module 204 is implemented using BSA++ and as such has all the capabilities built-in that the BSA Runtime provides, thus reducing the coding effort.

The UI of the presentation module 202 may be a fully modeled one, realized through the existing UI modeling tool, the UI Designer. Currently, it is a simple Quick Activity Floor-plan (QAF) embedding a hierarchical graph as the main control to render the BO structure.

The UI is the point of generation of all requests from the BO modelers and is coupled to the modeling module 204. The modeling module 204 of the BO Wizard is the primary object within the ByDesign layer and choreographs the frontend requests and their corresponding backend responses. It will do the necessary API calls to the MDRS BO for creation and modification of the BO model. The configuration that has been done by the BO modeler via the UI will be realized through this modeling module 204.

The modeling module 204 may be modeled in the MDRS 206 and implemented using the BSA++ framework.

FIG. 3 is a block diagram depicting an example of a metadata repository module (MDRS) 206. The modeling of the BOs via the modeling module 204 is possible only due to the fact that all meta-objects (such as BC) entity, data type, process agent, etc.) are Business Objects themselves in MDRS and as such, the full capability of the UI Oberon runtime stack can be used.

Therefore, the new BOs that are modeled in MDRS are all specific instances of the meta-data object MDRS_BUSINESS_OBJECT. The access to both the meta-data Objects and their instances has been standardized via the ESF APIs.

The MDRS as illustrated in FIG. 3 includes a business object metamodel module 302, an API layer module 304, a repository runtime module 306, and a persistence layer module 308.

The API layer module 304 (e.g., ESI Layer) is a well-defined access layer with uniform interface patterns and is remote accessible.

The BO metamodel module 302 includes a BO metamodel (nodes, composite associations, associations, attributes, attribute properties) that serves as a general metamodel for repository entities.

The repository runtime module 306 includes, for example, a BO processing framework used as implementation layer for consistency checks and the activation of models.

The persistence layer module 308 includes, for example, a BOPF-persistency with O/R-mapping, or any other persistency layer.

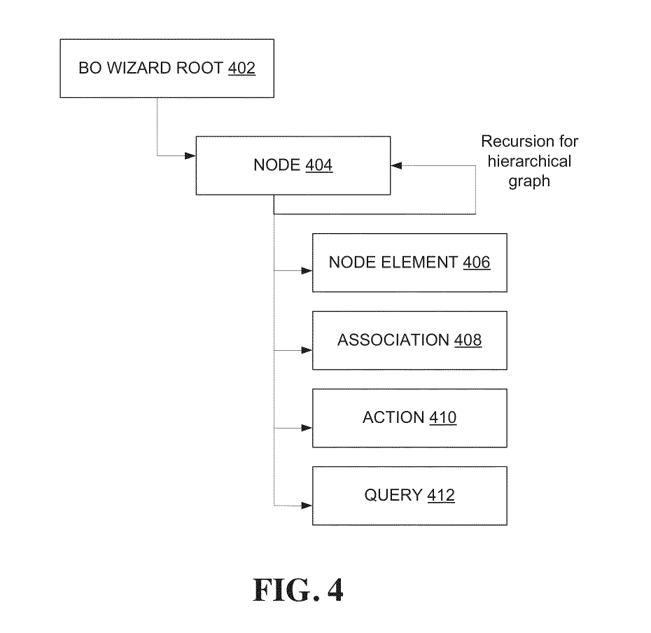

FIG. 4 is a block diagram depicting an example structure of a metadata repository wizard ECO module 204. It is of interest to understand the ECO structure, as the process of creating a new BO as well as modifying a pre-existing one is tied tightly to it. The ROOT 402 contains the generic information that the ECO needs about the current BO being modeled, such as the name, service provider class, the implementing framework, and so forth.

NODE 404 corresponds to all the nodes that a BO being modeled will have. They will all have the same meta-data, irrespective of their specific data-types. NODE has a special recursive association to itself which has been done to enable the hierarchical graph control to consume the ECO data. Hierarchical graph is used in the UI to render the BO structure.

The NODE_ELEMENT 406, ASSOCIATION 408, ACTION 410 and QUERY 412 are all children of NODE and they represent the elements, associations, actions and queries that each node of a BO can have.

While every NODE has to have a corresponding NODE_ELEMENT, it may not be necessary that it have an association, an action, or a query; therefore, the cardinalities are respectively 1:N, 0:N, 0:N, and 0:N. The ECO as such is a meta-data modeler and enabler. It has nothing to do with the actual data the modeled BOs contain.

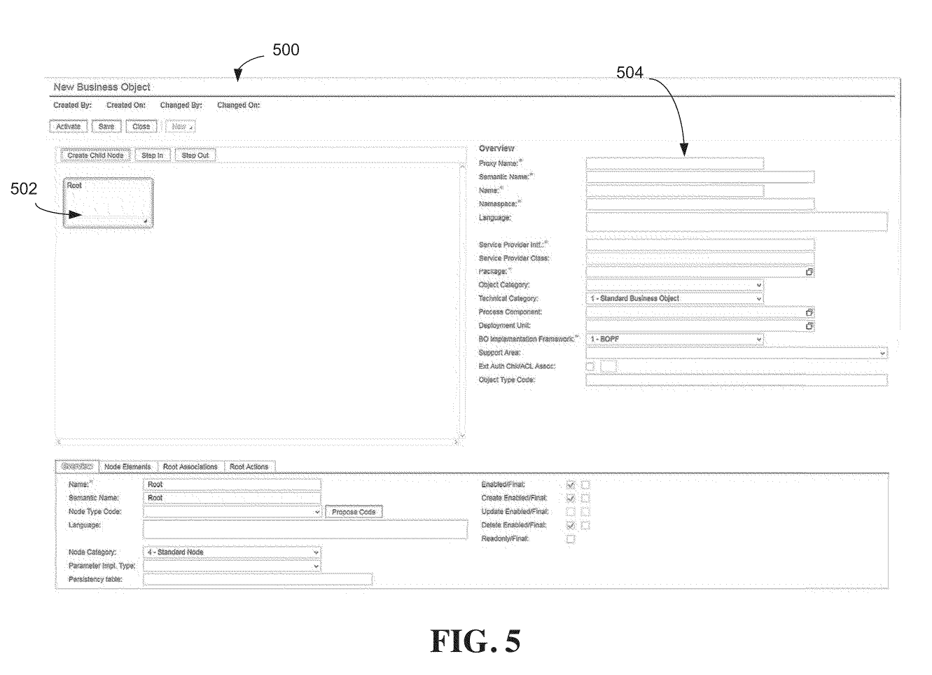

FIG. 5 is a screenshot depicting an example user interface 500 of a Business Object Wizard. The user interface allows a user to model and create a root node 502 using entries fields 504.

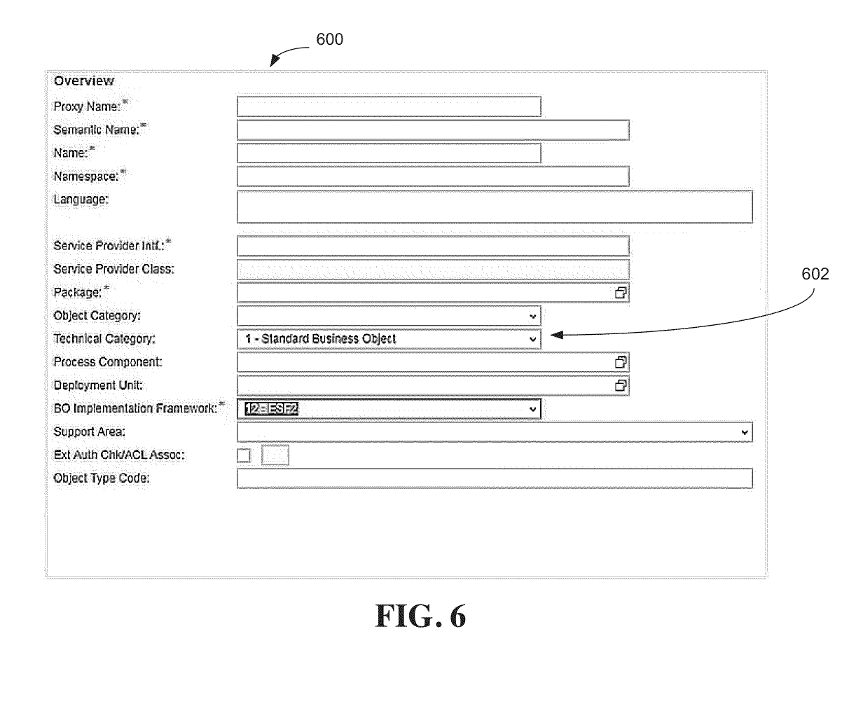

FIG. 6 is a screenshot depicting an example overview of a root node 600 of a newly modeled BO with entries fields 602 for creating the root node.

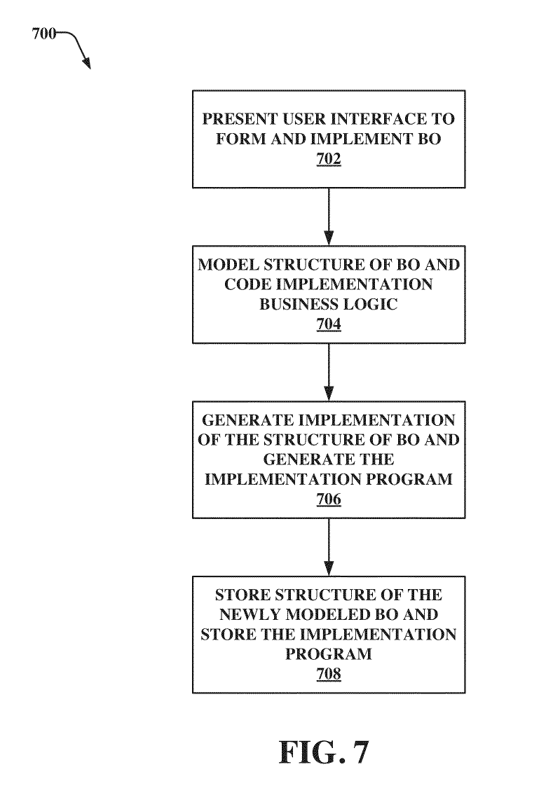

FIG. 7 is a flowchart 700 depicting an example method for creating or modeling a business object at a server from a user interface at a client.

At operation 702, a client is presented with a user interface to form and implement a business object at a server. In one embodiment, the presentation module 202 (BO Wizard UI) generates and provides the user interface. An example of the presented user interface is illustrated in FIG. 5.

At operation 704, a structure of the business object is modeled in a metadata repository at the server based on the user interface at the client and also the implementation of the business logic is coded in this operation. In one embodiment, the modeling module 204 provides the modeling of the business object in the MDRS 206 and stores the implementation program in the database 128.

At operation 706, an implementation of the structure of the business object is generated in the metadata repository (MDRS) 206 at the server. The newly modeled BO may be implemented using the user interface module 111 by generating the implementation program

At operation 708, the newly modeled business object is stored in the metadata repository (MDRS 206) at the server along with other pre-existing business objects models and the implementation program is also stored in the database 128.

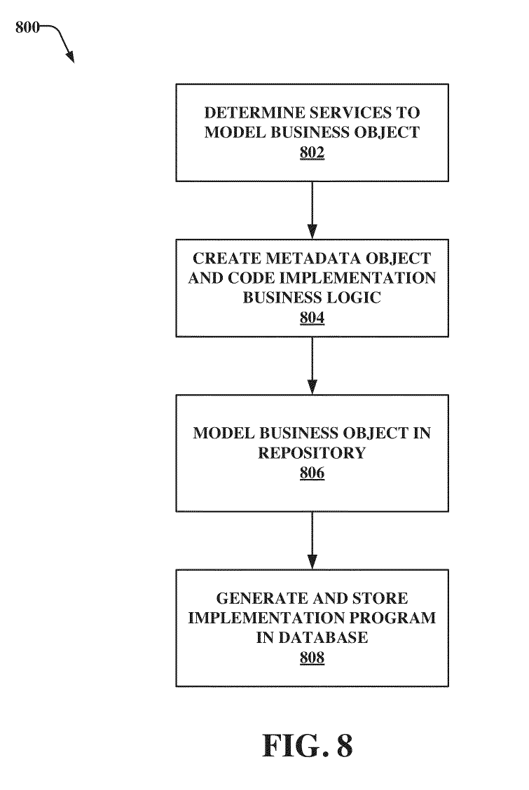

FIG. 8 is a flowchart 800 depicting an example method of using a Business Object Wizard Enhanced Controller Object to create and model a business object. At operation 802, services are determined to model a business object. At 804, metadata objects are created based on the services and the implementation business logic is coded. At operation 806, the business object is modeled in the repository (MDRS). At 808, the newly modeled business object's business logic implementation program is generated and stored in the database.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 120) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

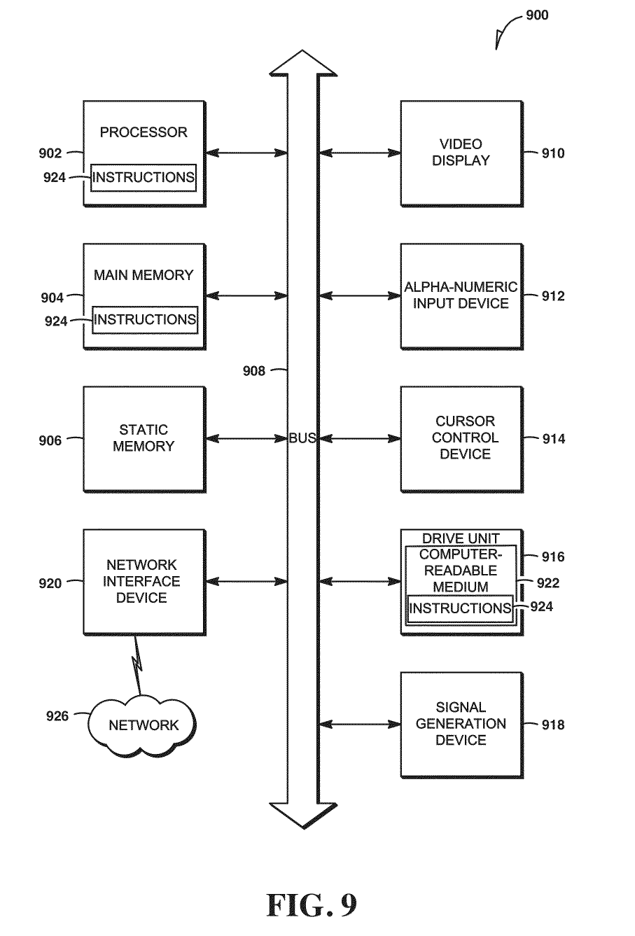

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display unit 910 a liquid crystal display (LCD) or a cathode ray tube (CRT)). The computer system 900 also includes an alphanumeric input device 912 (e.g., a keyboard), a user interface (UI) navigation (or cursor control) device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media. The instructions 924 may also reside, completely or at least partially, within the static memory 906.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable lead-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
presenting a client with a user interface to form and implement a business object at a server;
modeling a structure of the business object in a metadata repository at the server based on the user interface at the client; and
generating an implementation of the structure of the business object in a database at the server.

2. The computer-implemented method of claim 1, wherein the user interface comprises a plurality of business logics provided by an enhanced controller object (ECO), wherein the enhanced controller object is configured to call a corresponding MDRS application programming interface (API).

3. The computer-implemented method of claim 2, wherein ECO is configured to create and modify meta-objects for each business object.

4. The computer-implemented method of claim 2, wherein the ECO is configured to determine services to model the business object and to code an implementation logic for the business object.

5. The computer-implemented method of claim 1, further comprising:
storing a newly modeled business object in the metadata repository at the server, the metadata repository storing pre-existing business objects models.

6. The computer-implemented method of claim 2, wherein the business object from the ECO is modeled in the metadata repository and the implementation program is generated and stored in the database at the server.

7. The computer-implemented method of claim 6, wherein the metadata repository comprises a repository metamodel, an API layer, a repository runtime, and a persistency layer.

8. The computer-implemented method of claim 7, wherein the repository metamodel comprises a business object metamodel, wherein the API layer comprises a service layer, wherein the repository runtime comprises an implementation layer for checking consistency and activation of models, and a business object processing framework persistency layer.

9. The computer-implemented method of claim 2, wherein a structure of a metamodel of the ECO comprises a business object root, a node, a node element, an association, an action, and a query.

10. The computer-implemented method of claim 9, wherein the business object root comprises information including a name, a service provider class, and an implementing framework.

11. The computer-implemented method of claim 9, wherein the node corresponds to all nodes that the business object being modeled will have.

12. A system comprising:
a presentation module to present a client with a user interface to form and implement a business object at a server;
a modeling module implemented by at least one processor to model a structure of the business object in a metadata repository at the server based on the user interface at the client; and
an implementation module to generate an implementation of the structure of the business object in a database at the server.

13. The system of claim 12, further comprising:
an enhanced controller object (ECO) module to provide a plurality of business logics and to call a corresponding MDRS application programming interface (API).

14. The system of claim 13, wherein the ECO module is configured to create and modify meta-objects for each business object.

15. The system of claim 13, wherein the ECO module is configured to determine services to model the business object and to code the business logic of the business object.

16. The system of claim 12, further comprising:
a metadata repository to store a newly modeled business object and pre-existing business object models.

17. The system of claim 16, wherein the business object created or modified through the ECO module is modeled in the metadata repository and the implementation program is generated in the application server and stored at the database.

18. The system of claim 17, wherein the metadata repository comprises a repository metamodel, an API layer, a repository runtime, and a persistency layer.

19. The system of claim 18, wherein the repository metamodel comprises a business object metamodel, wherein the API layer comprises a service layer, wherein the repository runtime comprises an implementation layer for checking consistency and activation of models, and a business object processing framework persistency layer.

20. A non-transitory machine readable medium embodying a set of instructions that, when executed by one or more processors, causes the processor to perform a method, the method comprising:
presenting a client with a user interface to form and implement a business object at a server;
modeling a structure of the business object in a metadata repository at the server based on the user interface at the client; and
generating and storing an implementation of the structure of the business object at the server.
